(19) United States
(12) Patent Application Publication
(10) Pub. No.: US 2008/0298247 A1
(43) Pub. Date: Dec. 4, 2008

(54) Method and Apparatus for Vocoder Rate Control in a Wireless Network

(75) Inventors: Kumar Balachandran, Cary, NC (US); Rajaram Ramesh, Raleigh, NC (US); Havish Koorapaty, Cary, NC (US)

Correspondence Address: COATS & BENNETT, PLLC, 1400 Crescent Green, Suite 300, Cary, NC, 27518, US

(73) Assignee: Teefonaktiebolaget LM Ericsson (publ), Stockholm (SE)

(21) Appl. No.: 11/757,630

(22) Filed: Jun. 4, 2007

(51) Int. Cl. H04J 3/14

(52) U.S. Cl. 370/237

(57) ABSTRACT

A packet filter function in a wireless communication network monitors congestion and communicates a congestion indication to one or more vocoders. In one embodiment, the congestion indication comprises a vocoder source rate calculated by the packet filter function in response to the congestion. The reduced vocoder source rate frees system resources that can be allocated to new users to alleviate the congestion. The vocoder source rate may be communicated to the vocoder(s) in a variety of ways.

### BACKGROUND

The present invention relates generally to wireless communication systems, and in particular to a method and apparatus for network-initiated vocoder source rate control.

A vocoder (voice encoder/decoder) is a circuit that analyzes speech and generates digital data representing the speech, and inversely receives digital data representing speech and synthesizes the speech. Vocoders are employed at either end of a communication channel that transmits speech in data packets, such as for telephony over circuit-switched or packet-switched networks. Voice over Internet Protocol (VoIP) is typically employed as a means of transporting speech in such applications.

The Adaptive Multirate (AMR) standard specifies vocoders capable of encoding speech at a plurality of data rates, referred to herein as the vocoder source rate. Two variants of AMR exist—narrowband AMR and wideband AMR. Narrowband AMR includes eight modes with different vocoder source rents, from 12.2 kbps down to 4.75 kbps. This provides the traditional audio bandwidth of PSTN telephony of about 100-3500 Hz. AMR-WB includes nine modes with vocoder source rates from 6.6 kbps up to 23.85 kpbs, providing an audio bandwidth of 50-7000 Hz. In either AMR variant, a vocoder source rate is selected, possibly based on a measurement of channel quality (C/I, BER, FER, etc.). When the channel quality is high, a high vocoder source rate is selected, thereby improving perceived speech quality. When the channel quality is low, such as in the presence of interference, a lower vocoder source rate is selected, and a higher level of error correction coding is applied. This reduces the perceived audio quality, but ensures a low error rate through more robust coding. The lower rate vocoder may reduce the absolute maximum speech quality that can be achieved, but the resultant speech quality in the presence of channel impairments is typically better than that achieved when using a higher rate vocoder with a lower level of channel coding. Due to this adaptability, AMR vocoders are standardized 3GPP for GSM and WCDMA wireless communication systems. Furthermore, AMR vocoders are expected to be used for VoIP telephony in many modern and future wireless communication networks, such as High Speed Packet Access (HSPA), 3GPP Long-Term Evolution (LTE) and networks based on the IEEE 802.16 standards (known in the art as WiMAX).

While conventional AMR vocoders are typically adapted to changes in channel quality, the change of vocoder rate as a mechanism for lowering congestion in a packet data network has not been considered in any prior art.

### SUMMARY

A packet filter function in a wireless communication network monitors congestion, determines a vocoder source rate based on the congestion, and communicates the vocoder source rate to one or more vocoders. The reduced vocoder source rate frees system resources that can be allocated to new users to alleviate the congestion. The vocoder source rate may be communicated to the vocoder(s) in a variety of ways.

One embodiment relates to a method of adaptive vocoder source rate control by a packet filter in a wireless communication network implementing digital voice telephony. Traffic conditions in the wireless communication network are monitored. A level of congestion in the wireless communication network is determined based on the traffic conditions. A vocoder source rate is determined based on the congestion, and the vocoder source rate is communicated to a vocoder.

Another embodiment relates to a wireless communication network. The network includes a core network and a transcoding node connecting the core network to an external network terminating a voice call. The transcoding node includes a vocoder. The network also includes a base station connected to the core network and operative to provide wireless digital voice communication services with a mobile terminal terminating the voice call. The mobile terminal includes a vocoder. The network further includes a packet filter function operative to monitor congestion at the base station, calculate a vocoder source rate for one or more vocoders in response to the congestion, and communicate the vocoder source rate to one or more target vocoders in the network.

### BRIEF DESCRIPTION OF THE DRAWINGS

FIG. 1 is a diagram of the data structure of a vocoder speech frame.

FIG. 2 is a functional block diagram of a wireless communication network.

FIG. 3 is a flow diagram of a method of vocoder source rate control.

### DETAILED DESCRIPTION

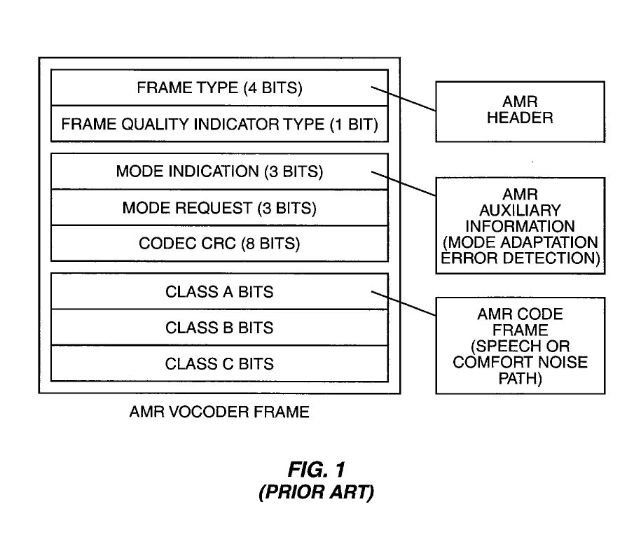

FIG. 1 illustrates the frame format for an AMR speech frame. The Mode Indication bits indicate the vocoder source rate being used to transmit the current speech frame, and the Mode Request bits request a particular rate option for succeeding transmissions. The Frame Quality bit denotes a lost transmission that does not have enough information to provide error concealment. The Frame Type bits identify the vocoder.

When using vocoders such as AMR in VoIP networks, it is possible that the traffic load on the network results in congestion. Congestion in a wireless communication network occurs mainly at a scheduler in the network that regulates the flow of data packets to the radio link. When an excessive number of users demand resources from the scheduler, the scheduler is forced to drop some users' packets in response to demands by other users.

Many wireless packet networks attempt to reserve bandwidth for voice telephony, while other classes of data traffic are allowed bandwidth resources using some appropriate criteria, such as proportional fairness. However, future data networks cannot charge excessive premiums for voice service, and cannot afford to reserve excessive resources for voice telephony.

Systems such as WiMAX may handle VoIP using Unsolicited Grant Service (UGS) or alternative services that can carry real-time traffic such as the extended real-time polling service (eRTPS). One problem with specialized bandwidth provisioning for voice telephony is that the ability of the network to handle large numbers of calls at peak usage times is compromised by the demands on bandwidth imposed by lower quality services at the same time. Packet data networks can handle voice telephony more effectively, and hence increase collective service quality, by lowering the vocoder source rate and hence decreasing speech quality on individual calls. AMR vocoders lower the source rate dynamically in response to increased interference levels that manifest themselves as increased error rates. However, the adaptation is too slow to alleviate congestion, and will result in higher numbers of dropped calls as users request service or get handed over. A more aggressive adaptation to lower vocoder source rates in response to large bandwidth demands by data traffic would improve system performance.

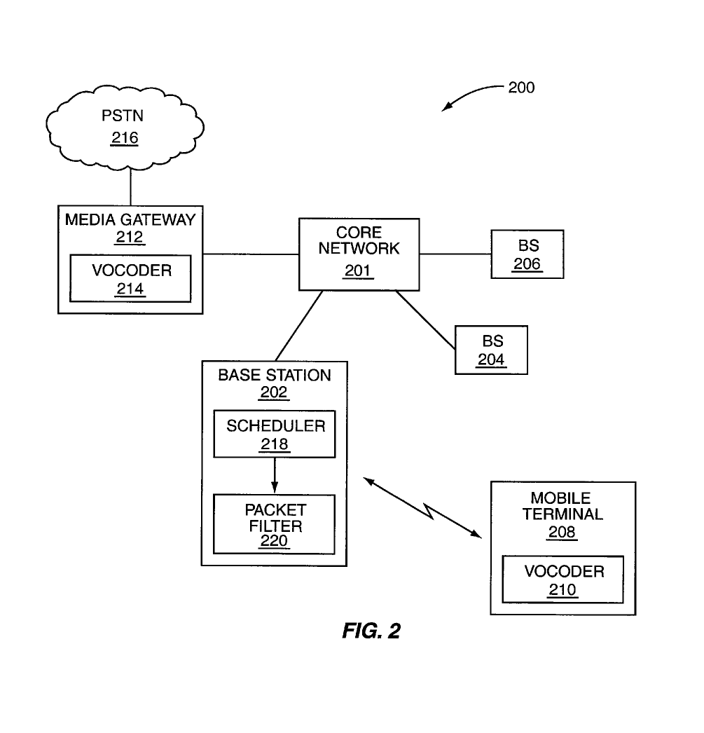

FIG. 2 depicts a wireless communication network 200. A Core Network 201 controls a plurality of base stations 202, 204, 206, also known in the art as network Access Points (AP). The base station 202 provides wireless voice and data communications with a subscriber mobile terminal 208. The mobile terminal 208 includes a vocoder 210 for encoding and synthesizing speech transmitted between the mobile terminal 208 and the network 200 in a digital format.

The Core Network 201 additionally connects to a Media Gateway 212, which in turn connects to one or more external networks 216, such as the Public Switched Telephone Network (PSTN) or the Internet. The Media Gateway 212 is a transcoding point in the network 200, translating content between various formats in the external networks 216 and the digital format employed by the wireless communication network 200. The Media Gateway 212 includes a vocoder 214 for encoding and synthesizing speech transmitted between the external network 216 and the network 200 in a digital format. In other embodiments, the vocoder 214 may be located at the base station 202 or another network 200 node.

According to one or more embodiments, the base station 202 includes a scheduler 218 that allocates radio resources among local users requesting communication services. The scheduler 218 may allocate resources to users according to a wide variety of criteria, such as the requested Quality of Service (QoS) level, knowledge of the type of content to transfer, current base station 202 utilization, channel quality, and the like. In one or more embodiments, the base station 202 (or other network 200 node) additionally includes a packet filter function 220. The packet filter 220 is aware of the QoS requirements of pending voice communication requests, and is aware of the ability to modify the vocoder 210, 214 source rate in the uplink and/or downlink.

The packet filter 220 further has access to the ability of the base station 202 to assign resources for packet transfers, and is hence aware of user traffic congestion. For example, in an OFDM system such as WiMAX, a radio resource manager or similar functional component associated with the scheduler 218 may indicate to the packet filter 220 that the base station 202 can allocate up to K time-frequency resources out of a maximum of N resources for the voice communication. This indication may be accompanied or superseded by an estimate of the number of source bits that can fit into the assigned resources. The estimate may alternatively be a fraction of the available resources that will correspond to source information, with the rest being assigned to error control and channel coding.

During periods of traffic congestion at the base station 202, the packet filter 220 may increase the number of users that can be provided voice service by the base station 202 by reducing the vocoder source rate of ongoing voice traffic. If channel quality does not demand higher coding, the reduction in vocoder source rate reduces the aggregate channel traffic, and hence allows additional users to access the channel. According to one or more embodiments, the packet filter 220 sends a congestion indicator to one or more vocoders 210, 214, and one or more of the vocoders 210, 214 reduce their vocoder source rate in response to the congestion indication.

In one embodiment, the congestion indication and/or desired vocoder source rate may be communicated to the media gateway vocoder 214 using a specialized control channel between the base station 202 and the vocoder 214, initiated using TCP/IP during call setup. Similarly, an indication of congestion and/or desired vocoder source rate may be communicated to the vocoder 210 in the mobile terminal 208 via a service control function. This may be done using a call control message that is communicated to the mobile terminal using the TCP/IP protocol. The congestion indication causes the vocoder 210 on the uplink to react quickly by lowering the vocoder source rate.

In one embodiment, the packet filter 220 utilizes the in-band control signaling channel within AMR to request a rate change by replacing the mode request information that is normally sent by a vocoder 210, 214. The packet filter 220 monitors data frames, identifies AMR voice frames, and alters the Mode Request bits in the AMR header prior to sending the data frame on to its destination. The packet filter 220 may alter the headers in both uplink and downlink voice frames. In one embodiment, the packet filter 220 additionally indicates that the modification to the mode request results from congestion control. In one embodiment, the packet filter 220 only adjusts the Mode Request downward—that is, the packet filter 220 will not alter the Mode Request bits to request a higher rate than that requested by the originating vocoder 210, 214 (which was based on channel quality measurements and represents the greatest rate the vocoder 210,214 can receive with an acceptable error rate). Upon receiving the request, the vocoder 210, 214 adjusts its source rate downward to alleviate congestion at the base station 202. The vocoder source rate adjustment can be performed in this manner as often as on a frame-by-frame basis, to dynamically track changing congestion conditions.

Values twelve through fourteen of the 4-bit Frame Type field of the AMR frame header are reserved for future use. In one embodiment, the modification of the Mode Request bits described above are indicated to the destination vocoder 210, 214 by defining an unused Frame Type encoding as a mode request modification indicator. When set by the packet filter 220, the mode request modification indicator indicates to the target vocoder 210, 214 that the Mode Request bits were altered by the packet filter 220, and were not requested by the source vocoder 210, 214. In another embodiment, an unused Frame Type encoding is defined as a congestion indicator. In this embodiment, the target vocoder 210, 214 receives an explicit indication that not only were the Mode Request bits altered by the packet filter 220, but also that the modification was made for the purpose of relieving congestion. The target vocoder 210, 214 may utilize this information, along with measurements of channel quality, to more intelligently adapt its vocoder source rate.

In still another embodiment, a new AMR frame format is defined for VoIP that includes all information in the existing AMR frame, and additionally includes a new field referred to herein as the Radio Network Mode Request. The Radio Network Mode Request field is utilized by the packet filter 220 to request a vocoder source rate to alleviate air interface congestion.

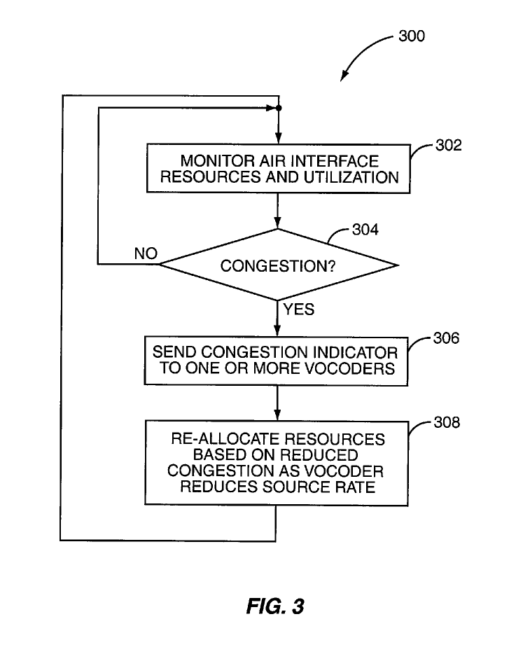

FIG. 3 depicts a method 300 of adaptive vocoder source rate control by a packet filter function 220 in a wireless communication network 200 implementing digital voice telephony. The packet filter 220 monitors air interface resources and utilization (block 302), and determines a level of congestion in the wireless communication network (block 304). If the congestion is below a threshold, the packet filter 220 continues to monitor the system (block 302). If the packet filter 220 detects congestion (block 304), it sends a congestion indicator, such as a desired vocoder source rate, to one or more vocoders in the network (block 306). The communication of the desired vocoder source rate to the vocoders may be over a specialized control channel; may utilize the in-band control channel of the AMR codec by altering the Mode Request field, optionally also including a mode request flag or congestion flag in a reserved encoding of a Frame Type field; or may comprise a Radio Network Mode Request field of a newly defined voice data frame header. The vocoders adjust their vocoder source rates in response to the congestion indication, and the base station scheduler 218 or other network function re-allocates network resources to reduce congestion (block 308).

Those of skill in the art will readily recognize that the packet filter function 220, while described herein and depicted in FIG. 2 as a separate functional entity, may, in any given implementation, comprise part of the functionality of the scheduler 218, or any other relevant functional unit in the base station 202. Both the scheduler 218 and the packet filter 220 may be implemented as dedicated hardware, as software programs executing on one or more controllers such as a microprocessor, digital signal processor, or the like, or may comprise any combination of hardware, software, and firmware, such as an FPGA, ASIC, or the like.

The present invention may, of course, be carried out in other ways than those specifically set forth herein without departing from essential characteristics of the invention. The present embodiments are to be considered in all respects as illustrative and not restrictive, and all changes coming within the meaning and equivalency range of the appended claims are intended to be embraced therein.

What is claimed is:

1. A method of adaptive vocoder source rate control by a packet filter in a wireless communication network implementing digital voice telephony, comprising:
monitoring traffic conditions in the wireless communication network;
determining a level of congestion in the wireless communication network based on the traffic conditions; and
communicating a congestion indication to a vocoder.

2. The method of claim 1 wherein monitoring traffic conditions in the wireless communication network comprises monitoring the system resources available for voice telephony services and the number of users requesting voice telephony services.

3. The method of claim 2 wherein the system resources available for voice telephony services are indicated to the packet filter by a network scheduling function.

4. The method of claim 3 wherein the network scheduling function provides the packet filter an estimate of the number of vocoder source bits that can fit into the available system resources.

5. The method of claim 3 wherein the network scheduling function provides the packet filter an estimate of the fraction of available system resources corresponding to vocoder source information.

6. The method of claim 1 wherein communicating the congestion indication to a vocoder comprises communicating the congestion indication to a vocoder at a network transcoding node via a control channel.

7. The method of claim 6 wherein the network transcoding node is a media gateway.

8. The method of claim 6 wherein the control channel is a congestion indication control channel between the packet filter and the vocoder at the network transcoding node, the channel initialized using TCP/IP during call setup.

9. The method of claim 1 wherein communicating the congestion indication to a vocoder comprises communicating the congestion indication to a vocoder in a mobile terminal via a service control function.

10. The method of claim 9 wherein communicating the congestion indication to the vocoder in a mobile terminal comprises communicating the congestion indication in a call control message using TCP/IP.

11. The method of claim 1 wherein the congestion indication comprises a vocoder source rate calculated by the packet filter function based on network congestion.

12. The method of claim 11 wherein communicating the vocoder source rate to a vocoder comprises altering the Adaptive Multirate (AMR) codec Mode Request bits in a voice frame and transmitting the frame to the vocoder.

13. The method of claim 11 wherein communicating the vocoder source rate to a vocoder comprises defining a voice frame header that includes a Radio Network Mode Request, setting the Radio Network Mode Request to request a vocoder source rate, and transmitting the frame to the vocoder.

14. The method of claim 1 wherein communicating the congestion indication to a vocoder comprises writing a flag using reserved encodings of a Frame Type field in an Adaptive Multirate (AMR) codec voice frame.

15. The method of claim 14 wherein the flag is a mode request modification flag.

16. The method of claim 15 wherein the flag is a congestion flag.

17. A wireless communication network comprising:
a core network;
a transcoding node connecting the core network to an external network terminating a voice call, the transcoding node including a vocoder;
a base station connected to the core network and operative to provide wireless digital voice communication services with a mobile terminal terminating the voice call, the mobile terminal including a vocoder; and
a packet filter function operative to monitor congestion at the base station and send a congestion indication to one or more target vocoders in the network.

18. The network of claim 17 wherein the packet filter function is operative to communicate the congestion indication to one or more vocoders in the network over a specialized control channel.

19. The network of claim 18 wherein the target vocoder is in the transcoding node, and the specialized control channel is established during call setup.

20. The network of claim 18 wherein the target vocoder is in the mobile terminal, and the specialized control channel comprises a call control message.

21. The network of claim 17 wherein the congestion indication comprises a flag using reserved encodings of a Frame Type field in an encoded speech data frame header.

22. The network of claim 21 wherein the flag is a mode request modification flag.

23. The network of claim 21 wherein the flag is a congestion flag.

24. The network of claim 17 wherein the congestion indication comprises a vocoder source rate calculated by the packet filter function based on congestion.

25. The network of claim 24 wherein the packet filter function is operative to communicate the congestion indication to one or more vocoders in the network by intercepting a voice data packets and altering a Mode Request field in the packet header to request the vocoder source rate.

26. A packet filter function in a base station of a wireless communication system implementing digital voice telephony, comprising:
a packet filter function operative to receive traffic condition information, determine a level of congestion in the wireless communication network based on the traffic conditions, and communicate a congestion indication to a vocoder.

27. The packet filter function of claim 26 wherein the packet filter function is further operative to calculate a vocoder source rate, and to communicate the vocoder source rate to a vocoder.
